(19) United States
(12) Patent Application Publication
(10) Pub. No.: US 2013/0134000 A1
(43) Pub. Date: May 30, 2013

(54) LANDING GEAR SHOCK ABSORBER METERING USING PIVOTING JOINT

(71) Applicant: James Ning, Oshawa (CA)

(72) Inventor: James Ning, Oshawa (CA)

(73) Assignee: Messier-Dowty Inc., Ajax (CA)

(21) Appl. No.: 13/304,489

(22) Filed: Nov. 25, 2011

(51) Int. Cl. F16F 9/342; B64C 25/58

(52) U.S. Cl. 188/322.13

(57) ABSTRACT

A metering pin assembly, for use in an aircraft landing gear shock absorber, that is operable to move within the shock absorber, independently of the shock absorber, to respond to movement of the landing gear under subjected load.

### FIELD OF THE INVENTION

The invention relates to shock absorber metering in aircraft landing gear and in particular to the use of a pivoting metering pin for use in a shock absorber.

### BACKGROUND OF THE INVENTION

Shock absorbers, or shock struts, are used in aircraft landing gear to assist in cushioning the landing impact of the aircraft. The shock absorber absorbs and/or dissipates the energy produced on impact when the aircraft lands and the landing gear contacts the ground.

Different types of shock absorbers are known and include the use of hydraulic fluid and gas as the energy absorbing component. In general, the shock absorber includes two telescoping cylinders that define, internally within the shock absorber, two chambers. The lower chamber is often referred to as a piston, and contains hydraulic fluid, and the upper chamber the cylinder, which contains gas, generally air or nitrogen. The chambers are generally separated by a plate, often referred to as the orifice plate, or other structure, that has an orifice within it through which the fluid, contained in the lower chamber within the shock absorber, may travel. Fluid, found in the lower chamber, is forced through the orifice at the moment of impact, which compresses the gas in the upper chamber thereby absorbing the energy produced on impact. Shock absorbers often include a metering pin that is connected to the lower reciprocating cylinder and is positioned to move through the orifice, in the orifice plate, when the lower cylinder telescopes within the upper cylinder.

When a load is placed on the landing gear, the shock absorber is compressed and the piston, or lower chamber, telescopes within the cylinder, or upper chamber. This motion forces fluid into the upper chamber and the gas within the upper chamber is compressed. At this time the energy of the impact is absorbed. After the stroke is complete, the gas in the upper chamber expands and forces the fluid back through the orifice and into the lower chamber. The metering pin, being received within the orifice, restricts the size of the orifice opening and thereby controls the flow of fluid from the upper chamber to the lower chamber. This slow metering of the fluid reduces any rebound within the shock absorber.

Several different versions of the above arrangements are known. The metering pin may be a cone-like shape which allows for control over staged fluid flow through the orifice. Alternatively, the metering pin may includes a series of apertures that provide fluid pathways through the metering pin. In operation, there is a considerable amount of wear on the metering pin as it approaches and passes through the orifice. When a load is placed on the landing gear the landing gear is subjected to both lateral and vertical movement. Such movement can cause the shock absorber, and in particular the internal components, such as the metering pin, to become slightly misaligned. This can result in the metering pin coming into contact with the orifice plate and causing wear on the metering pin as it is forced through the orifice plate.

While some solutions have been attempted to avoid excessive wear on the metering pin, such as using a floating orifice plate and/or using a stainless steel pin, there is still a need to address the above concerns. Designs, such as floating orifice plates, can be complicated and require additional parts to be included within the shock absorber. The inclusion of additional parts can lead to the possibility of more components that may fail or become damaged and therefore require replacement. While using stronger, more wear resistant material may delay the requirement for replacing a worn metering pin, it will be understood by those skilled in the art that the mass of materials used in the aircraft industry is of great importance. Components made from heavier materials will increase the overall mass of the landing gear which will have an impact on other components of the aircraft and also cost. There is therefore a continual need to reduce the overall mass of components used in aircraft and further there is a need to provide components that may be easily replaced, as and when required.

### SUMMARY OF THE INVENTION

There is provided, herein, a metering pin assembly that is operable to move within the shock absorber independently from the movement of the shock absorber when placed under load.

There is provided, herein, a shock absorber having a metering pin assembly with a pivoting joint.

The metering pin assembly, described herein includes a base, operable to connect to a piston assembly of a landing gear shock absorber and a projection, pivotably attached to the base.

In one embodiment, the metering pin assembly includes a connection point that attaches the projection, or damping section of the pin assembly, to the base of the pin assembly. The connection point allows for pivotal movement of the projection relative to the base.

In an alternate embodiment the metering pin assembly includes a base that is operable to connect to a piston assembly in an aircraft landing gear shock absorber, and a projection, pivotably attached to the base.

In one embodiment the projection comprises an attachment means that is operable to allow pivotable attachment of the projection to the base. In one embodiment, the projection and the attachment means are integral. In another embodiment, the projection and the attachment means are separate pieces. In one embodiment, the attachment means is at least one fastener.

In one embodiment, the projection is operable to pivot within a first plane. In another embodiment, the projection is operable to pivot in more than one plane.

In one embodiment, the projection includes plurality of apertures. In use, fluid is able to flow through each of the apertures. In an alternate embodiment, the projection has a cross sectional profile that differs along at least a portion of its length. In another embodiment, the projection includes a plurality of apertures and a cross sectional profile that differs along at least a portion of its length.

### BRIEF DESCRIPTION OF THE DRAWINGS

The present invention will now be described in further detail with reference to the following figures:

FIG. 1 shows a cross sectional view of one example of a prior art landing gear shock absorber with metering pin;

FIG. 2A is a schematic of prior art metering pins, used in shock absorbers on aircraft landing gear;

FIG. 2B shows one embodiment of a prior art metering pin, used in shock absorbers on aircraft landing gear;

FIG. 3A is a cross sectional view of one embodiment of the metering pin described herein;

FIG. 3B is a side view of the metering pin of FIG. 3A

FIG. 3C is another side view of the metering pin of FIG. 3A; and

FIG. 4 is a cross sectional view of an aircraft landing gear shock absorber including the metering pin, described herein.

### DETAILED DESCRIPTION OF THE PREFERRED EMBODIMENTS

There is provided a metering pin that adapts to movement within a shock absorber and allows for flexible movement into and through the orifice in the orifice plate located within the shock absorber, thereby minimising possible wear on the metering pin when moving through the orifice.

The metering pin, described herein, is for use in an aircraft landing gear shock absorber, and is operable to move within the shock absorber, independently of the shock absorber, to respond to movement of the landing gear under subjected load.

The metering pin provided requires a small number of components which reduces the possibility of multiple component failures.

The metering pin provided may be formed from light weight material thereby reducing the overall mass of the shock absorber.

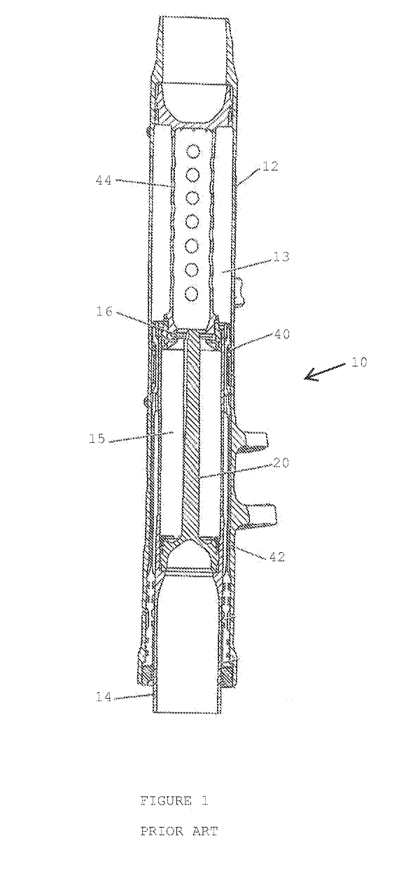

The present invention will now be described in detail with reference to the accompanying FIGS. 1-4.

FIG. 1 shows a cross section of one example of a prior art landing gear shock absorber including a metering pin within it. The landing gear shock absorber is indicated generally at numeral 10. The shock absorber 10 includes an outer cylinder 12, that defines a top nitrogen/hydraulic fluid chamber 13, and an inner cylinder 14, also referred to as a piston assembly, that defines a bottom or lower hydraulic fluid chamber 15. Located between the outer cylinder 12 and the inner cylinder 14 is an orifice plate having an orifice 16 located in the centre. Connected to the upper surface of the piston assembly 14 is a metering pin 20 that is sized to fit through the orifice 16.

As can be seen in FIG. 1, additional components of the landing gear shock absorber include a rebound ring and chamber, indicated at numerals 40 and 42, an internal support tube 44, for receiving the metering pin when it extends into the fluid chamber 13, and other known components that will not be discussed in detail herein, but are known to persons skilled in the art.

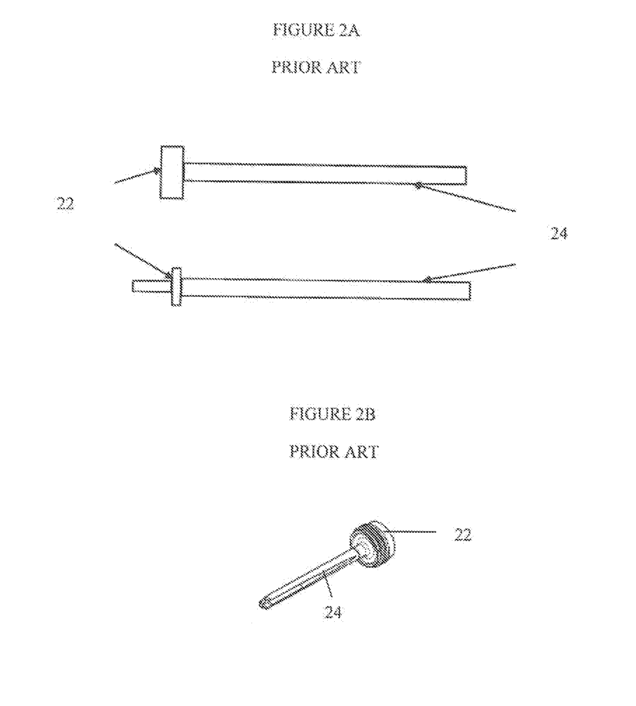

FIG. 2A is a schematic diagram of metering pins used in the prior art. Each metering pin 20 includes a base 22 and a damping section 24. In use, the base 22 is connected to the upper surface of the inner cylinder 14. FIG. 2B is one example of a metering pin known in the prior art.

As stated above, the fixed connection of the metering pin 20 to the inner cylinder 14 results in the metering pin 20 moving whenever the inner cylinder 14 moves. When a load is placed on the landing gear, this fixed connection can result in misalignment of the metering pin 20 with the orifice 18 which can result in wear on the metering pin 20 as it is forced through the orifice 18 and abuts the orifice plate 16.

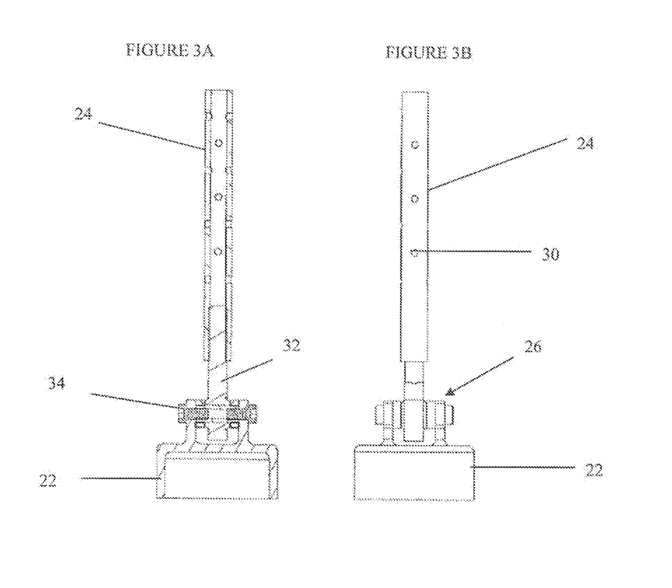

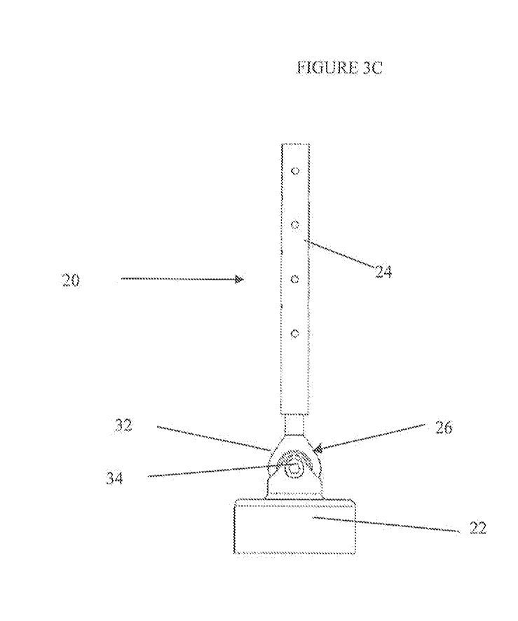

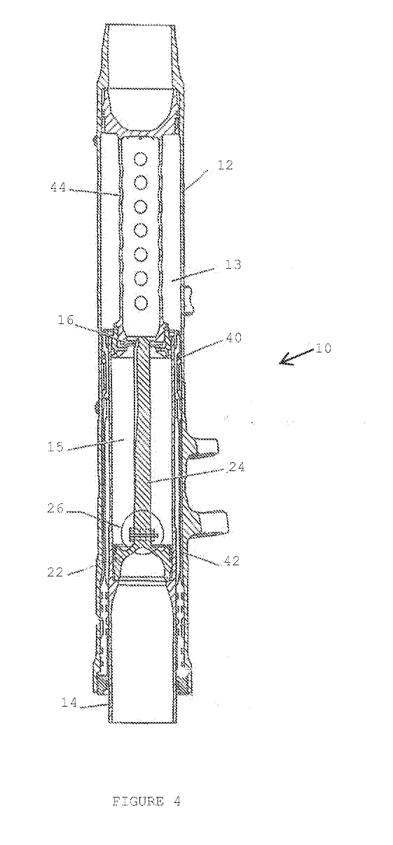

Turning to FIGS. 3A-C, the metering pin 20 of the present invention is shown. The metering pin 20 includes a base 22, for attaching the metering pin 20 to the inner cylinder 14, or piston, and a damping section 24 extending outwardly from the base 22. The damping section 24 may also be referred to as a projection. The damping section 24 includes a plurality of apertures 30 through which fluid is able to flow. When in use, and the metering pin 20 extends through the orifice 18 in the orifice plate 16, fluid is able to flow through the apertures 30 within the damping section 24. It will be understood that control of the fluid flow through the orifice 18 may occur through either (i) apertures located within the damping section, as described above, that control fluid flow through the metering pin; (ii) variations in the metering pin profile that provide changes in the profile of the passage for fluid through the orifice, as the pin passes through the orifice; and (iii) combinations of (i) and (ii). While the present invention is shown having a damping section 24 including a series of apertures 30, it will be understood that it may also include a damping section 24 having a varied profile, or combinations of a varied profile and apertures located within the damping section 24.

In contrast to the metering pins described above, in reference to FIG. 2, the damping section 24 of the metering pin 20 shown in FIGS. 3A-3C, and described herein, is pivotably connected to the base 22. The pivotable connection point is indicated at numeral 26. The pivotable connection point 26 allows for movement of the damping section 24 relative to the base 22. Movement of the damping section 24 relative to the base 22 can occur in both a fore-aft and left-right direction due to the spherical connection joint. This freedom of movement provides for greater flexibility in the positioning of the metering pin during engagement with the orifice.

In the embodiment shown in FIGS. 3A-C, the damping section 22 includes an attachment point 32 that is pivotally connected to the base 22 using fasteners 34. The attachment point 32 may be integral with the damping section 22 or, as shown, may be a separate component that is connected to the damping section 22, for example using pins or a threaded connection.

The base 22 of the metering pin 20 is connected to the inner cylinder 14 by any means known, for example, the base 22 may be clamped to the inner cylinder 14 using one or more brackets. The base 22 may be connected to the inner cylinder 14 using a locking wire. Alternatively, the base 22 may be attached to the inner cylinder by a nut and bold type arrangement where the metering pin assembly passes through a portion of the cylinder and is fastened using a nut.

In use, when the metering pin 20 is connected, via the base 22, to the inner cylinder, or piston assembly, 14, and a load is placed on the landing gear, the damping section 24 is operable to pivot about the connection point 26, shown clearly in FIG. 4. This pivotable connection point 26 allows the damping section 24 to respond to any geometric change in the landing gear, when a load is placed on it, and to be able to readjust its position to move through the orifice 18 with no load being imposed on the damping section 24.

The design of the metering pin 20, described herein, allows for the bending of the landing gear under load to impact the geometry of the metering pin while not impacting the function of the metering pin due to its ability to pivot about the connection point 26. In other words, the damping section 24 of the metering pin 20 is able to move independently of the shock absorber, when a load is placed on the shock absorber.

The metering pin 20, described herein, provides a metering pin 20 having minimal components, which reduces costs and the requirement for maintenance of additional components, that is subjected to less wear and stress, compared to the traditional metering pins, described herein, that is able to perform its function, irrespective of the load, and impact thereof, on the landing gear.

The metering pin 20, including the damping section 24, base 22 and components of the connection point 26, may be formed from light weight material, that is able to meet the requirements of the aircraft industry, such as aluminium, stainless steel and composite.

It will be understood that the metering pin assembly, as described herein, can be produced separately from the shock absorber and attached thereto during assembly of the landing gear. Alternatively, the metering pin assembly may be used to retrofit pre-existing landing gear shock absorbers, replacing the metering pins currently used. It will be understood that if the metering pin assembly is used to retrofit pre-existing equipment, re-qualification of the components of the shock absorber may be required.

While this invention has been described with reference to illustrative embodiments and examples, the description is not intended to be construed in a limiting sense. Thus, various modification of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

Any publications, patents and patent applications referred to herein are incorporated by reference in their entirety to the same extent as if each individual publication, patent or patent application was specifically and individually indicated to be incorporated by reference in its entirety.

1. A metering pin assembly, for use in an aircraft landing gear shock absorber having a piston assembly received within an outer cylinder; the pin assembly comprising:
a base, operable to connect to the piston assembly; and
a projection, pivotably attached to the base.

2. The metering pin assembly according to claim 1, wherein the projection comprises an attachment means, the attachment means being operable to allow pivotable attachment of the projection to the base.

3. The metering pin assembly according to claim 1, wherein the projection is attached to the base using at least one fastener.

4. The metering pin assembly according to claim 1, wherein the projection is operable to pivot within a first plane.

5. The metering pin assembly according to claim 1, wherein the projection is operable to pivot in more than one plane.

6. The metering pin assembly according to claim 1, wherein the projection comprises a plurality of apertures to allow fluid flow therethrough.

7. The metering pin assembly according to claim 1, wherein the cross sectional profile of the projection differs along at least a portion of the length of the projection.

8. The metering pin assembly according to claim 2, wherein the projection and the attachment means are integral.
